(19) United States
(12) Patent Application Publication
(10) Pub. No.: US 2014/0360104 A1
(43) Pub. Date: Dec. 11, 2014

(54) STAGE HAVING MOVABLE PARTS AND ADVERTISING MEANS

(71) Applicant: Paulo Roberto Jannotti Newlands, Rio de Janeiro (BR)

(72) Inventor: Paulo Roberto Jannotti Newlands, Rio de Janeiro (BR)

(21) Appl. No.: 13/913,398

(22) Filed: Jun. 8, 2013

(51) Int. Cl. E04H 3/26; E04H 17/00; G09F 17/00; E04H 3/28

(52) U.S. Cl. CPC E04H 3/26; E04H 3/28; E04H 17/00; G09F 17/00; G09F 2017/0025
USPC 52/7; 52/741.1

(57) ABSTRACT

Stage Having Movable Parts and Advertising Means. A method and apparatus is disclosed for the aim of enhancing the visual perception of attendees present to shows where the use of protective elements such as fences surrounding a stage, act as a physical obstacle between the show and the public during given moments such as in the initial presentation of contenders in a wrestling contest for instance, or at the winner proclamation act in the end of the session, when preferably the fence should be removed for the benefit of the show's visibility, effect that can be achieved by means of mechanical force applied over certain parts of the stage's sections such as the stage's fence or the stage's floor or even both simultaneously, to move them up and downwards or horizontally, providing at the same time the means for introducing advertising facilities through the use of the stage's movable structure for this goal.

### FIELD OF THE INVENTION

The present invention relates to the field of public entertainment performed with the use of stages or the like, and more specifically to the apparatus therein inserted with the aim of applying the desired movements to those stages, as well as to the field of advertisement.

### BACKGROUND OF THE INVENTION

Although the present invention might be applied to a wide range of formats, solutions and circumstances, it will be however herein exemplified based on the newly introduced concept of “cages” used for practicing wrestling combats such as in the mixed martial arts, for which a temporary stage is mounted inside a venue where the fight will occur, being such cages generally called “octagon”, a geometric format that will therefore be used as our explanatory model.

That kind of octagonal stage received the “cage” denomination due to the fact that, to protect wrestlers and prevent them to fall down from the stage's floor to the outside soil, a fence has been installed all over the periphery of the stages creating so the appearance and atmosphere of a cage inside which the fight will run.

The existence of the fence, although of fundamental importance for the execution of the fights, is not necessary, and even undesired, during certain moments of the show such as during the wrestlers presentation in the beginning of the fight, or at the end when the referee announces the fight's result when that fence will act unavoidably as an unnecessary visual barrier for the public attending to the event and should preferably be removed in such special moments, which is actually the main goal of the present patent, along with the advertising method herein created.

To achieve that goal is then necessary to insert in the movable stage a variety of mechanical resources which movements are achieved preferably by means of an electric, pneumatic, hydraulic power or any other kind of mechanical force capable to give the stage's parts the required movements.

Besides and taking advantage from the movements that will be given to the movable floor and to the fence by the present invention, an advertising system can also be inserted along with the whole apparatus by simply inserting specific devices jointly with the fence or the floor, as will be further elaborated.

Previous patents have somehow attempted to overcome similar disadvantage existing in public events although trying to resolve different problems than the ones herein faced.

The following US patents, for example, were devoted to rationalize a better seats distribution inside a venue: U.S. Pat. No. 7,107,724 of Scott Suprina and Tony English for “Interchangeable Stadium Seating and Entertainment Stage”; U.S. Pat. No. 6,029,406 of Staelin; U.S. Pat. No. 4,688,357 of Deaton; U.S. Pat. Nos. 5,921,032 and 5,7494,383, both of Labinski, U.S. Pat. No. 2,668,331 of Horn and U.S. Pat. No. 4,580,776 of Burkinshaw.

### OBJECTS OF THE INVENTION

It is therefore an object of the present invention to improve the quality of individual participation in public events in which stages or similar devices are used.

It is also an object of the present invention to remove visual barrier between the attendees at public events and the event itself, in certain given moments during that event whenever stages or similar devices are used.

It is also an object of the present invention to improve the individual interest and attraction of individuals when attending public events whenever stages or similar devices are used.

It is also an object of the present invention to improve the overall quality in a public event by providing stages or similar devices fitted with the means for moving parts of that stage or similar devices.

It is also an object of the present invention to provide an apparatus for rapidly and interchangeably moving sections of a stage or similar devices.

It is also an object of the present invention to provide an apparatus capable to display instant and direct advertising during certain given moments during an event.

It is also an object of the present invention to overcome disadvantages of the prior art.

### SUMMARY OF THE INVENTION

In keeping with these objects and others that may become apparent, this invention relates to a method and apparatus to enhance the visual perception of attendees present to shows where the use of protective elements such fences surrounding a stages act as a physical obstacle between the show and the public during given moments such as in the initial presentation of contenders in a wrestling contest, for instance, or at the winner proclamation in the end of the session, when preferably the fence should be removed for the benefit of the show's visibility.

This aim can be achieved in an efficient manner without disturbing the playing field by means of mechanical force applied over certain parts of the stage's sections such as the on stage's fence or the stage's floor or even both simultaneously, to move them up and downwards or horizontally, providing at the same time the means for introducing advertisement media with the use of the stage's movable structure for this goal.

The proper functioning of the present invention is guaranteed by the construction of a solid structure both for the fence and the stage's floor which apart of being independent one from the other are both twinned by specific contact points that might be raised and lowered vertically through adequate power, making so the patent viable.

Once that goal is achieved, the quality of the show for the attendees will be enhanced due to the inexistence of visual barriers between the public and the scenes during certain moments causing the general view of the show to be straight and clean.

### BRIEF DESCRIPTION OF THE DRAWINGS

The present invention will be better understood in connection with the accompanying drawings, in which:

FIG. 1 is a top plan view of an octagon stage commonly used in events of mixed martial wrestling in its usual configuration;

FIG. 2 is a side view showing the attendees observation line being disturbed by the stage's fence;

FIG. 3 is a side view showing clean attendees observation line after removal of the stage's fence;

FIG. 4 is an expanded view of the two main movable elements introduced by the present patent in the conventional octagon cages, both having racks inserted at the end section of its sustaining legs.

FIG. 5 is an exploded view showing separately, the movement of each movable element towards the next element in order to configure the movable stage of the present patent;

FIG. 6 is a top view of the octagon stage that exemplifies the present invention;

FIG. 7 shows the sequence by which floor and fence were vertically moved into the inner space of the surrounding platform in order to configure the movable stage of the present patent;

FIG. 7A and 7B show the adjustment made up for the fence to be lifted by elevated gears;

FIG. 8 shows the fence's downwards movement sequence, having at the final step its lower section stowed inside the surrounding platform;

FIG. 9 shows the upwards movement sequence of the stage's floor, having as final movement its lower section being stowed inside the surrounding platform;

FIG. 10 shows the combined movement of stage's fence and floor, upwards and downwards respectively, by which the fence was moved down and the floor went up to get the two movable sections in the horizontal level to enhance the observation field of attendees;

FIG. 11 is a lateral amplified view of the rack that was introduced at the lower sections of the sustaining legs on both fence and floor to give them vertical movements through a pinion driven by adequate source power such as an adjacent electric motor, for example;

FIGS. 12A and 12B show a lateral view of a pinion connected to an electric engine and positioned in the middle of two racks to show how the pinion rotation causes the two racks to move in opposite directions;

FIGS. 13A and 13B Illustrates an alternative way, among many others, that can be applied for moving either the fence or the stage's floor by using for example a hydraulic jack;

FIGS. 14A and 14B show another alternative way to move the stage's floor or the fence, by using lifting scissor;

FIG. 15 shows through the sequence from A to D the assembling process to set up a banner inside its holder to be further displayed with the help of the fence's structure during its vertical movement;

FIG. 16 shows how the banner is applied along with the stage's fence.

### DETAILED DESCRIPTION OF THE DRAWINGS

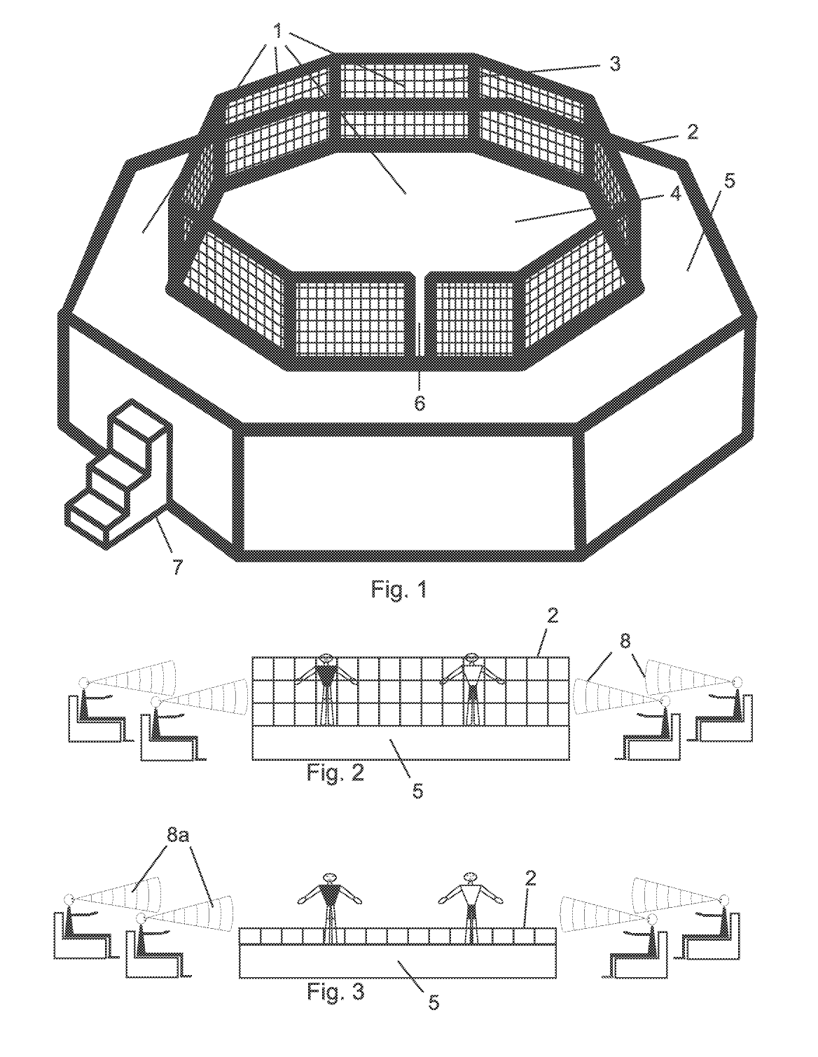

A general view of an octagon cage 1 is given on FIG. 1, as it is currently used in wrestling contests, outlining the six main elements from which the octagon stage in formed namely the fence 2 with net 3, the floor 4, the surrounding platform 5, a gate 6 and stair 7.

In its usual current configuration, those octagons stages have actually introduced a very useful new concept to this sportive activity by creating additional protection to the wrestlers given by the peripheral fence that prevents the fighters from falling down from the stage, creating at the same time an ultimate fighting atmosphere inside the cage from where only one wrestler must leave as the fight winner.

The existence of the fence 2, although of fundamental importance for the execution of the program is not necessary and even undesired during certain moments of the show such as during the wrestlers presentation in the beginning of the contest, or at the end when the referee announces the fight result, moment when that fence 2 will act unavoidably as an unnecessary visual barrier for the public attending to the event, as illustrated in FIG. 2, that shows the attendees observation line 8 being disturbed by the stage's fence 2.

To overcome the inconvenient, that visual barrier should preferably be removed in such special moments to clean the attendee's observation field 8a, as disclosed by FIG. 3, where the fence 2 was moved down and the stage's floor 4 was displaced upwards, removing so any obstacle for a clean visual field 8a of the stage.

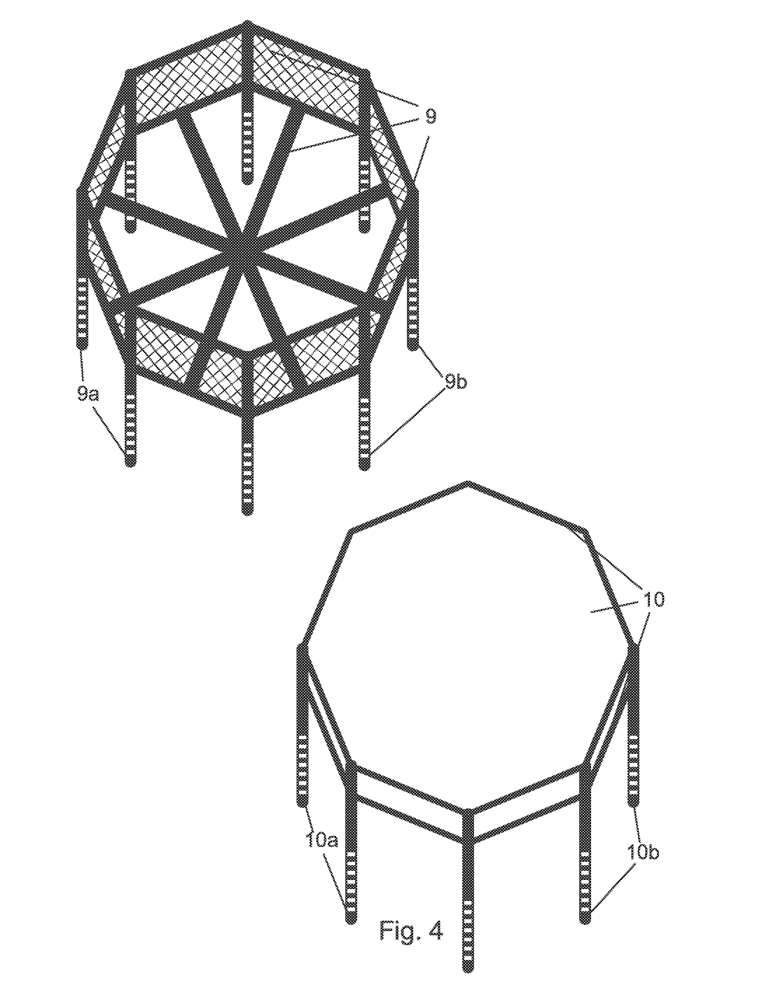

On FIG. 4 an expanded view is given of the two movable elements introduced in the conventional octagon cages by the present patent, namely the movable fence 9 with legs 9a fitted with a rack 9b and the movable floor 10 with legs 10a fitted with a rack 10b at its end.

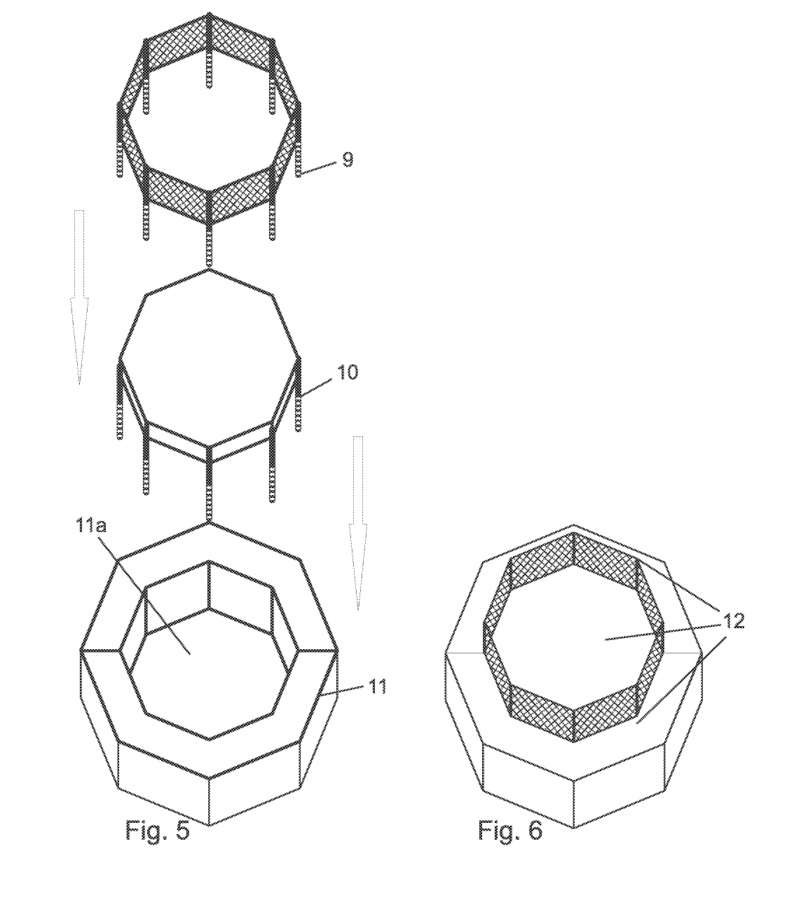

FIG. 5 shows the sequential movement performed by the movable elements of the octagon of the present patent in order to remove the visual barrier between the attendees and the scene at the stage. Thus, the movable floor 10 with legs 10a fitted with a rack 10b at its end will overlap the movable fence 9 with legs 9a fitted with a rack 9b at its end, in such a position that both racks 9b and 10b will be positioned face to face in order to allow its traction and movement by a pinion 14 as will be better explained ahead.

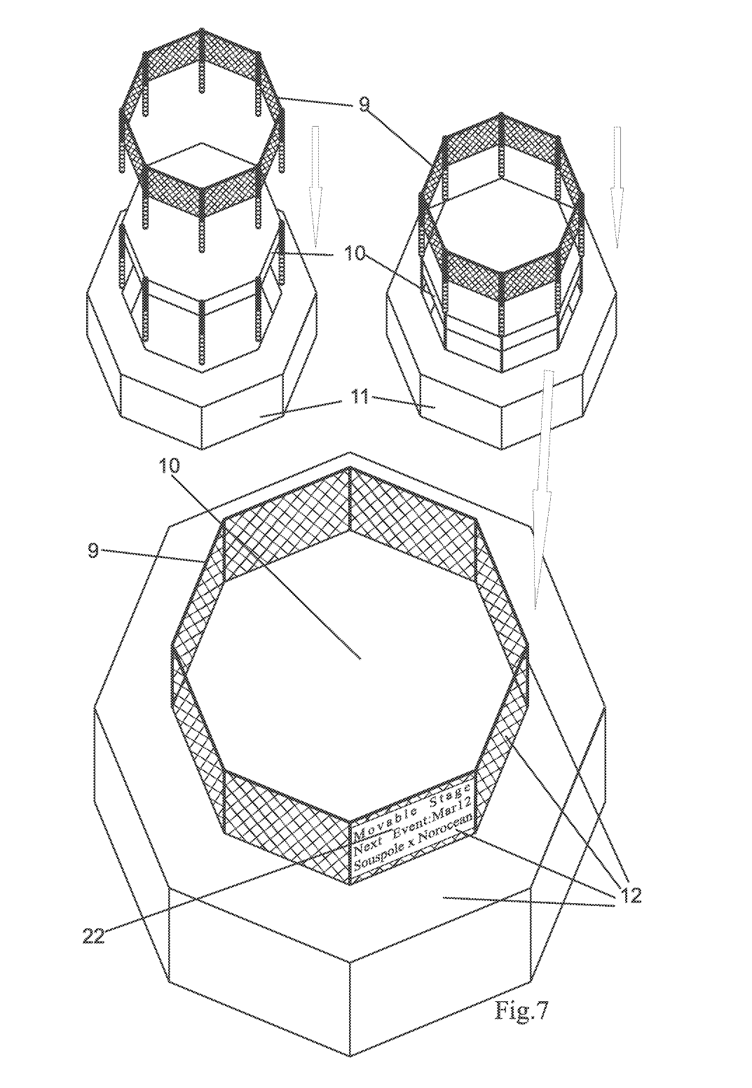

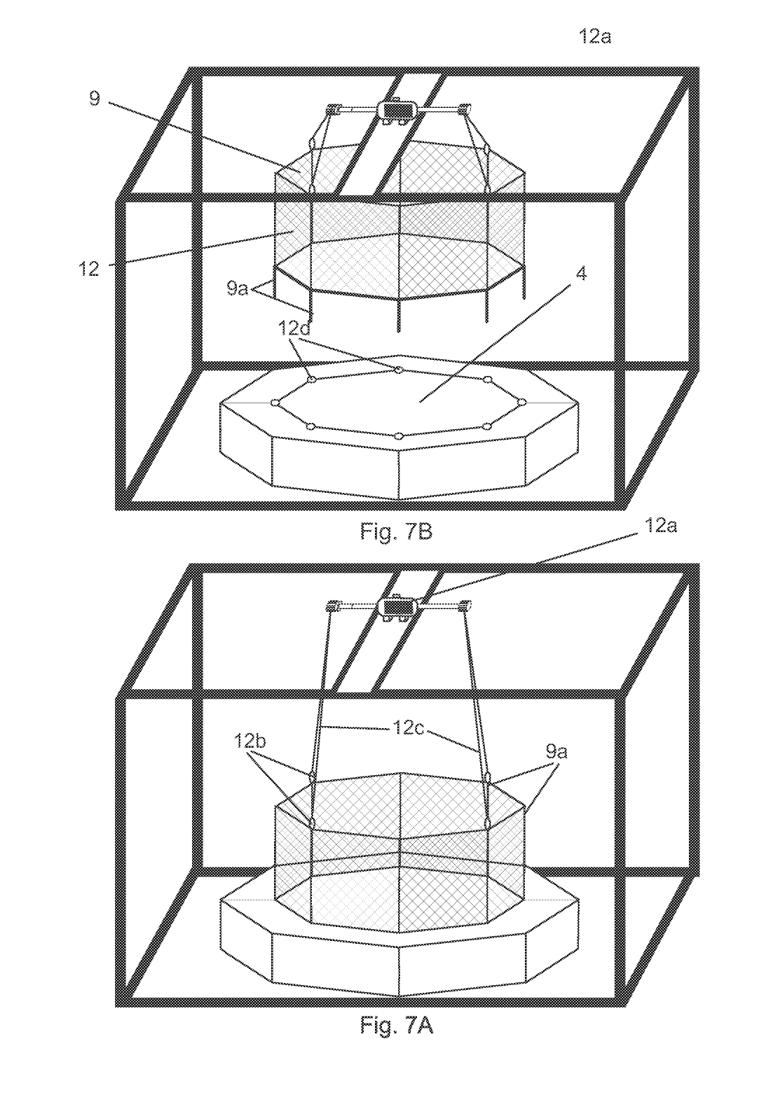

Afterwards, the set so formed by the movable fence 9 and by the movable floor 10 will be inserted into the inner space 11a, existing at the center of the surrounding platform 11 which is the first step to set up the “Stage Having Movable Parts and Advertising Means” 12 of the present patent shown on FIG. 6. This same routine is shown again through another angle in FIG. 7.

Taking from the same FIG. 7, it is possible to conceive an alternative method of having the movable fence 9 raised over the stage 12 up to a desired height in order to have the observation field of the attendees 8a unblocked and freed from obstacles, which can be achieved by means of elevated gears 12a positioned between the stage's floor 4 and the venue's ceiling, and sent back to its original position to be leveled to the stage's floor 4 again in certain given moments as when the announcement of the fight is finished and the combat is ready to start.

FIG. 7A shows some adjustments and devices that consequently must be inserted to the fence 9 in order to get it prepared for this aim, such as O ring 12b, hooks or similar elements positioned at the upper end of the fence's legs 9a in order to allow the fence 9 to be entirely lifted by the gears 12a with the help of steel ropes 12c, for example, as well as housings 12d, better shown in FIG. 7B, with their hollow upper end positioned at the same level of the stage's floor 4 and having internal depth long enough to accommodate the fence's legs 9a in a safe and stable resting position during the fights.

FIG. 7B shows the fence already lifted by elevated gears with the help of adjustments and devices as described in FIG. 7A.

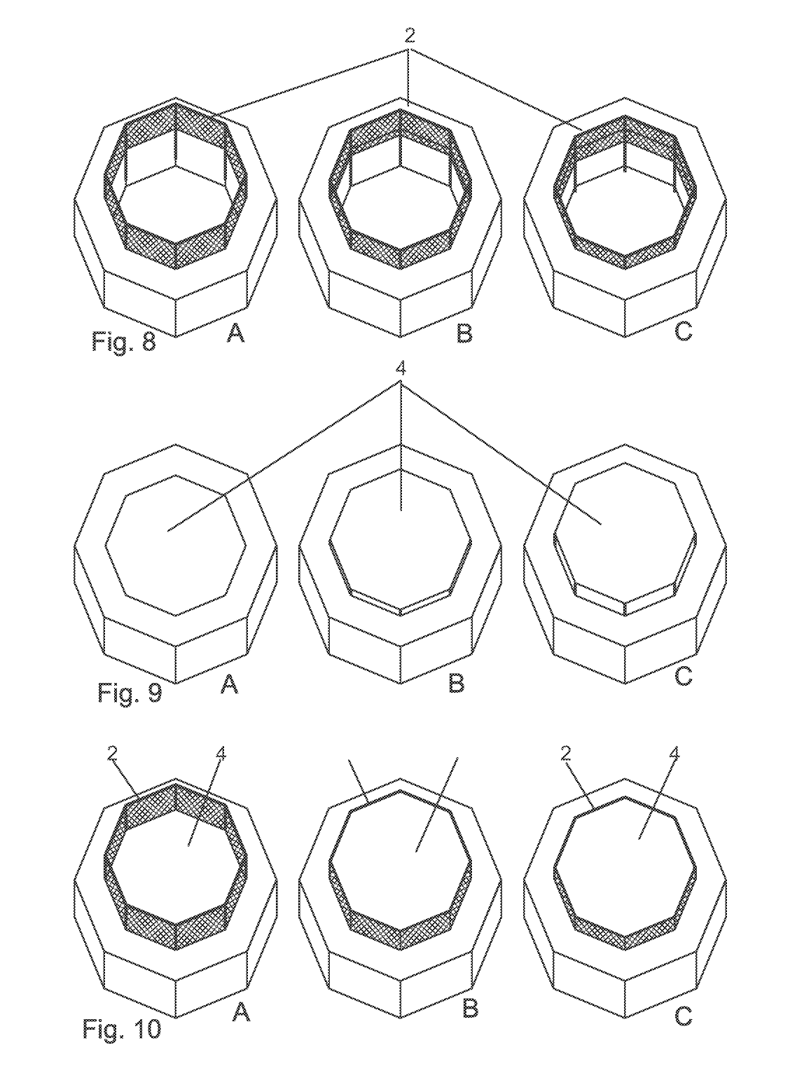

FIG. 8 till FIG. 10 exhibits the operational process of raising and lowering the movable elements of the movable stage of the present patent, namely the fence 2 and the floor 4, in order to increase the clean visual field over the stage, increasing therefore the drama and the suspense of the audience for the benefit of the viewers and of the show, as well.

On FIG. 8, from A to C, the up and down movement of the fence 2 is reproduced, through which it is possible to follow how the visual field of attendees is improved when the fence 2 is located below their visual observing line.

On FIG. 9, is now reproduced the up and down movement of the stage's floor 4, showing again how the visual field of attendees is improved when that movable element is located within their clean visual observation field. FIG. 9C shows the pinnacle of the upwards movement, when both wrestlers and referee will be completely exposed for a free glance of the public.

On FIG. 10 is finally shown the up and down combined movements towards inverse directions of both the fence 2 and the stage's floor 4 that upon completed, will result in the full removal of any visual barrier between the show and the public, when the stage will be dramatically changed into a cage.

To achieve that goal it is necessary to outfit the movable stage with a variety of mechanical resources in which movements are preferably achieved by means of electric, pneumatic, hydraulic power or any other kind of adequate mechanical force, able to supply for the movable elements of the stage, the desired movements.

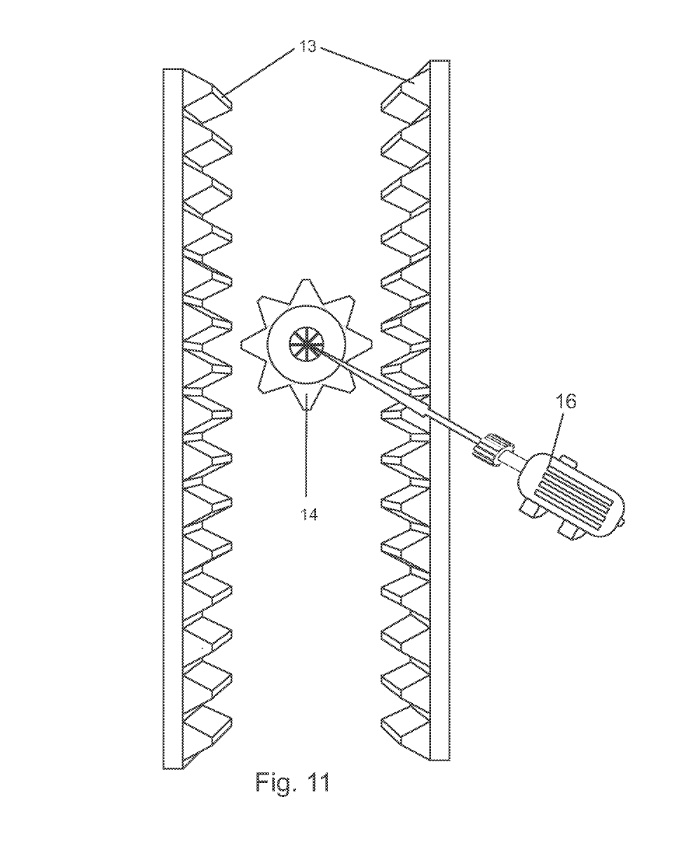

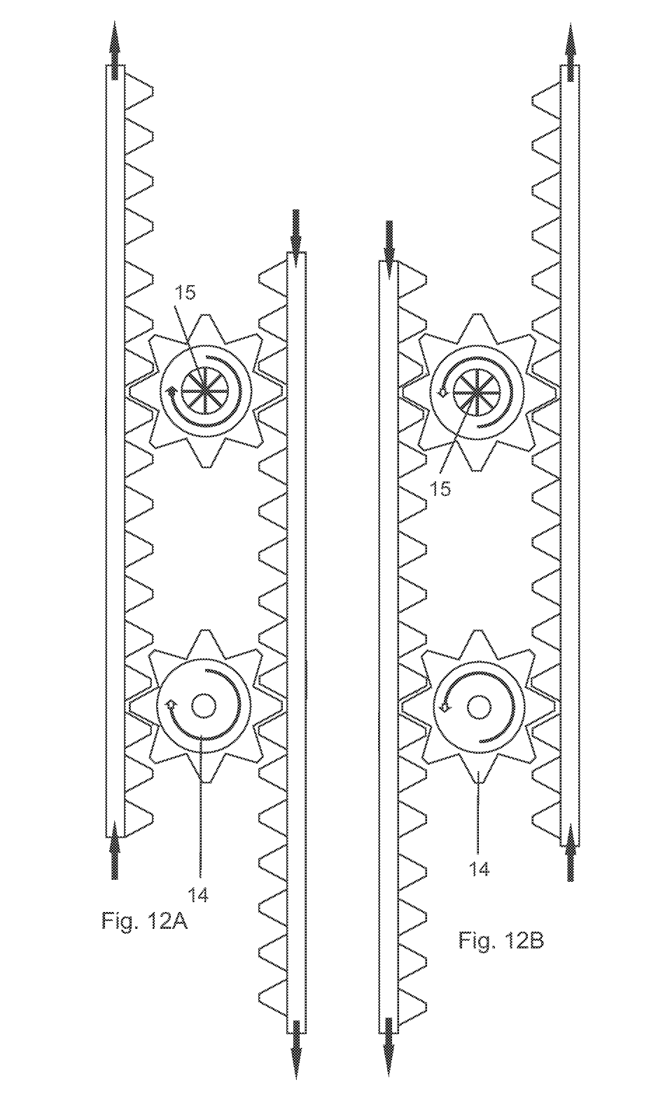

One, out of the many ways to do that is exemplified in FIG. 11 that shows an amplified view of the racks 13 existing at the lower sections of the sustaining legs 9a and 10a on both stage's fence 2 and floor 4, to give them vertical movements by means of a master pinion 14 with equivalent proprieties and measures.

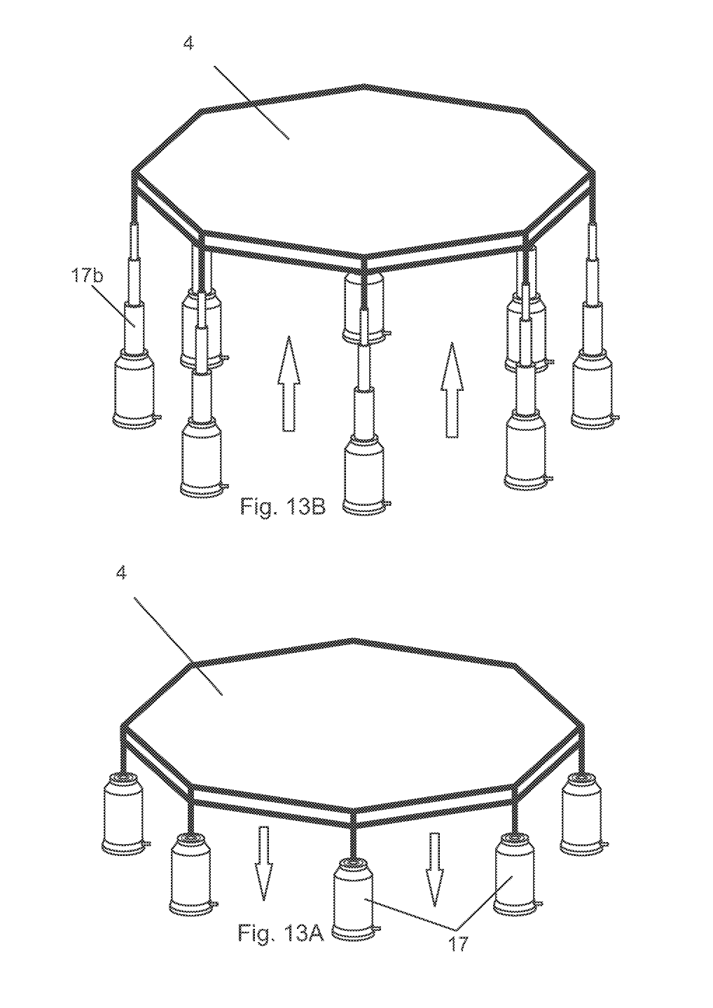

Once those two equivalent racks 13 existing in the lower section of the sustaining legs, as described by FIG. 4, are positioned face to face, after the whole set of movable elements, namely fence 2 and floor 4 were inserted in the inner space 11 a existing in the surrounding platform 11 and positioned steady at the upright position, ready for use therefore, a rotating movement is applied to the master pinion 14 by means of an adjacent electric gear 16, as disclosed in FIG. 11, which makes the master pinion 14 rotate with the help of an auxiliary pinion 15, clockwise or inverse as needed, forcing the two legs to move vertically in opposite directions meaning that, while one of the two movable element is going up, the other one is going down, according to the signaling arrows exposed in FIGS. 12 A and 12B, attending this way the requirements for removal of visual barriers between the stage's scene and the attendees.

Optionally, it is also possible to move only one of the two movable elements at a time by either raising only the stage's floor 4 or lowering only the fence 2, which will result in the same desired effect of enhancing the clean observation field 8a of the attendees.

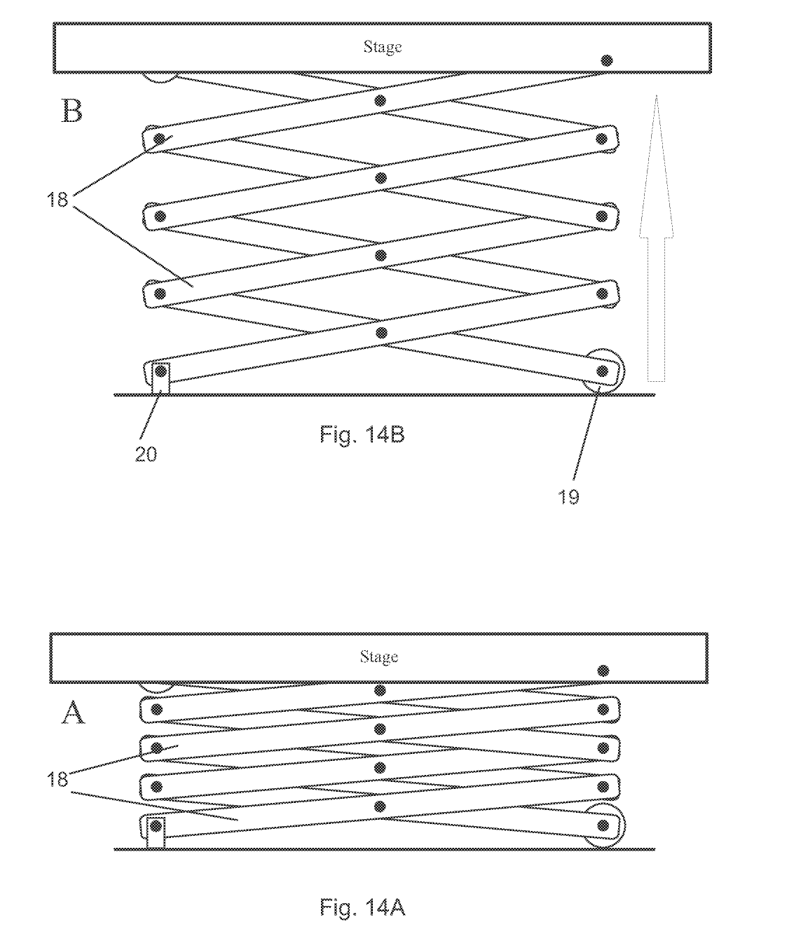

FIG. 13A and 13B show a construction variation for the same objective of removing visual barriers, through the use of jacks 17 fitted with telescopic cylinders 17b, for example, in which the legs of the movable elements, namely fence 2 and stage's floor 4, or even any other selected part of those structures are attached and consequently moved vertically along with those telescopic cylinders 17b whenever those devices are activated through the valve 17a, until they are leveled below the observation field of attendees, as explained through the sequence of movements from A to B, on FIG. 14.

Mini-space, high-performance, double-action telescopic cylinders jacks 17 are easy to find in the market. Capable to afford long life in heavy-duty use, they are engineered and constructed for easy installation and minimal maintenance, as well requiring minimum over-all installation dimensions.

It should be noted that during the wrestling time when the fence 2 will be submitted to extra force applied by the heavy wrestlers' bodies, the telescopic cylinders 17b of the jacks 17 will be returned to the retracted position after the return flow on the telescopic cylinders has been applied, being anyway all the elements of the mobile stage dully anchored and tight by means of clamps or any other adequate equipment to assure maximum resistance and durability to its mechanism.

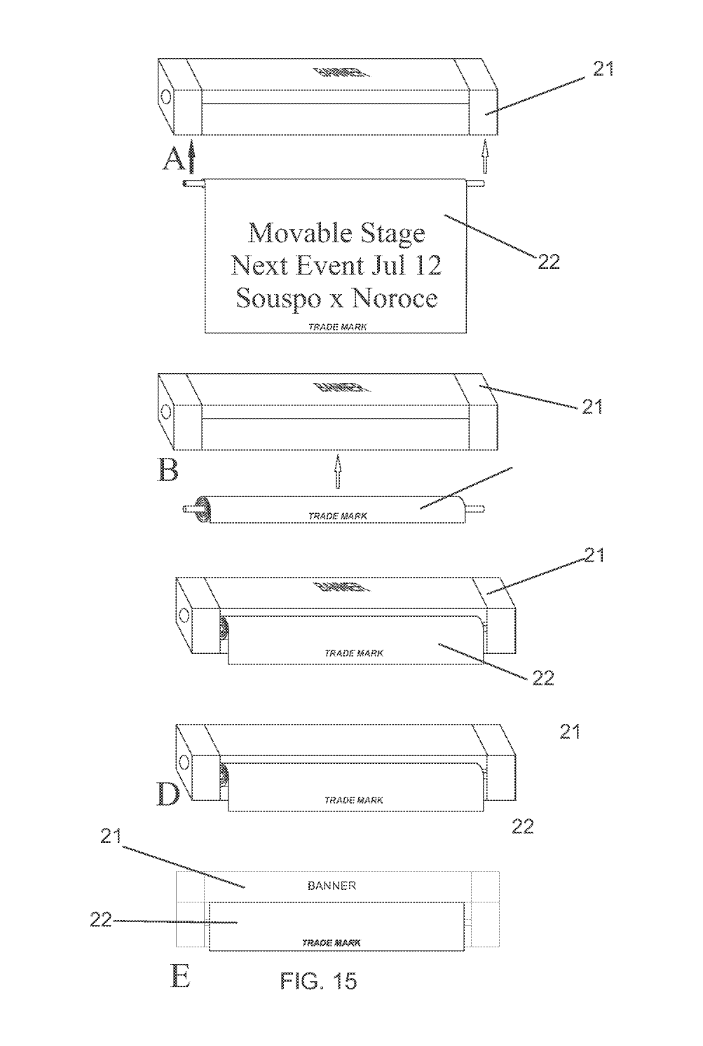

FIG. 15 discloses another construction variation to give movement to the stage's floor by applying lifting scissor 18 for the desired vertical movements, being the whole system fixed by the clamp 20 and rolling it over wheel 19, as described by the sequence of figures from A to B. This system can be simultaneously used along with any other system capable to give the fences the required movements such as the telescopic jacks 17, for example.

Besides and taking advantage from the movements that will be given to the movable floor 4 and to the fence 2 by the present invention, an advertising system might also be inserted along with the whole apparatus by simply inserting specific devices jointly with the stage's fence 2 or the stage's floor 4, as will be further elaborated.

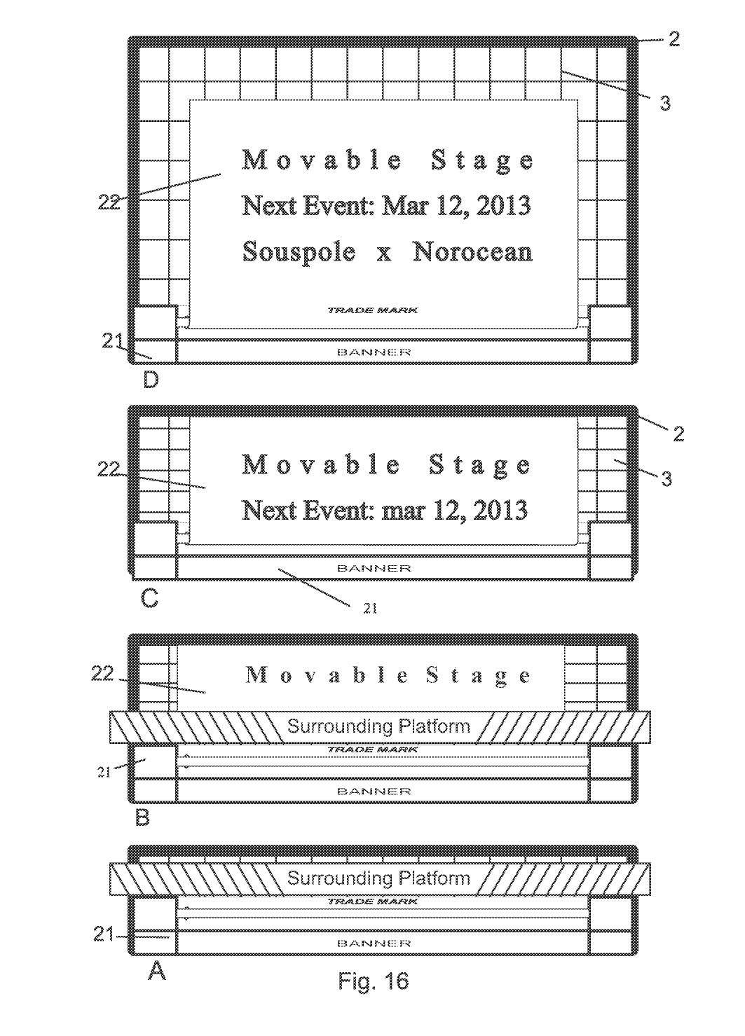

FIG. 16 illustrates through the sequence from A to E, how a banner 22 and its holder 21 can be constructed and aggregated to the Stage Having Movable Parts and Advertising Means.

One essential success element on public events is related to how efficient its announcement is made, before and during the event, and sometimes after. For this aim many communication channels might be employed including written institutional or commercial messages of public interest concerning to what is going to happen at that specific place.

The vertical movements allowed by the present patent represents an additional opportunity to dispose to the event's attendees another information channel in the pause between the combats, when idle moments can be filled with useful information related to the event.

That goal can be achieved through the use a banner holder 21, as one example among many others feasible devices adequate for this function, that can be displayed with the support of the fence 2 during its vertical movements, which will be used to exhibit advertising messages of any type during given moments when nothing of the attendee's interest is happening inside the stage.

As so, the adjacent advertising kit to the stage's fence 2, shown as an example in FIG. 16, bears a banner holder 21, preferably of the automatic roll-up type where the desired advertising banner 22 will be embodied, being that banner holder 21 positioned either at the upper or at the lower end of the fence 2, which up and down movements will be used to automatically pull and exhibit the banner 22 in the desired moments, and retract and close it when needed.

On FIG. 17, a possible configuration of this embodiment is disclosed, in which the banner holder 21 is positioned underneath the upper edge of the surrounding platform 5 and close to the contiguous section of the fence 2, in such a way it can be tightly fixed to the fence 2 by clamps, hooks or any other adequate device and preferably controlled by remote means, goes upwards along with the fence 2 and retracts back to the banner's holder 21 again, when commanded through the same remote control, after elapsed the desired exposition period.

It is further noted that various modifications may be made to the present invention, within the scope of the invention, as noted in the appended claims.

I claim:

1. A method and apparatus conceived to enhance the visual perception of attendees present to public shows when the use of protective elements such as fences surrounding a stage act as a physical barrier between the show and the public wherein those obstacles should preferably be removed for the benefit of the show visibility, for which it will be given mobility to those inconvenient parts in order to fit them with movable means through mechanical force which is to be applied when desired, providing at the same time the means for introducing advertising facilities through the use of the stage's movable structure for this goal, further comprising the steps of improving the quality of individual participation in public events;

2. A method and apparatus to enhance the visual perception of attendees present to shows, as in claim 1, wherein stages or similar devices fitted with movable parts are used to improve the overall quality of public event by providing stages or similar devices with the means for moving its structure;

3. A method and apparatus to enhance the visual perception of attendees present to shows, as in claim 1, wherein the apparatus is provided with means for rapid interchange of its moving sections;

4. A method and apparatus to enhance the visual perception of attendees present to shows, as in claim 1, wherein an apparatus is capable to display instant and direct advertising during certain given moments during an event in order to increase the drama by creating a progressive suspense atmosphere inside the cage in order to improve the individual interest and attraction of individuals when attending public events;

5. A method and apparatus to enhance the visual perception of attendees present to shows, as in claim 1, wherein the mobility to certain parts of the movable stage could be applied over any part of the stage's structures such as the stage's fence or the stage's floor or even to both simultaneously, to move them up and down, or horizontally, and at the same time disclosing advertising messages.

6. A method and apparatus to enhance the visual perception of attendees present to shows, as in claim 1, further comprising the construction of a solid structure for the fence and for the stage's floor as well, which apart of being independent one from the other, are both twinned by specific contact points where the racks are located and that might be raised and lowered vertically through adequate power applied over a rotatable pinion, making so the patent viable.

7. A method and apparatus to enhance the visual perception of attendees present to shows, as in claim 1, wherein the visual barrier should be removed in special moments to clean the attendee's observation field, by moving down the stage's fence and up the stage's floor, or only the stage's fence or the stage's floor up and down, one at a time.

8. A method and apparatus to enhance the visual perception of attendees present to shows and events, as in claim 1, wherein the two movable elements introduced in the conventional octagon cages by the present patent, namely movable fence and floor are sustained by legs fitted preferably at their lower section with racks equivalent in measures and characteristics, in such that those racks, when positioned face to face are capable to give the legs opposite vertical movements by means of a rotatable pinion with equivalent proprieties and measures of the racks.

9. A method and apparatus to enhance the visual perception of attendees present to shows, as in claim 1, wherein a rotating movement is applied to the pinion, by means of an auxiliary electric gear which makes the pinion rotate clockwise or inverse, as needed, forcing the two legs to move vertically in opposite directions meaning that, while one of the two movable element is going up, the other one is going down, consequently attending the need for removal visual barriers between the stage's scene and the attendees.

10. A method and apparatus to enhance the visual perception of attendees present to shows, as in claim 1, wherein the movable floor with legs fitted with a rack at its end overlaps the movable fence with legs also fitted with a rack at its end, in such a disposition that both racks are positioned face to face to allow its traction by the pinion, being the set so formed inserted into the inner space existing at the center of the surrounding to set up the Stage Having Movable Parts and Advertising Means.

11. A method and apparatus to enhance the visual perception of attendees present to shows, as in claim 1, further comprising a construction variation for the same objective of giving movements to some parts of the stages' structure through the use of jacks fitted with telescopic cylinders, in which the legs of the movable elements, namely fence and stage's floor, or even any other selected part of those structures are attached and consequently moved vertically along with those telescopic cylinders whenever that device are activated, until those movable elements are leveled to the desired position.

12. A method and apparatus to enhance the visual perception of attendees present to shows, as in claims 1 and 8, wherein the jacks will be returned to the retracted position after the return flow on the telescopic cylinders has been applied, being anyway all the elements of the mobile stage dully anchored and tight by means of clamps or any other adequate equipment to assure maximum resistance and endurance to its mechanism.

13. A method and apparatus to enhance the visual perception of attendees present to shows, as in claim 1, further comprising another construction variation for the same objective of giving movements to some parts of the stages' structure by applying lifting scissor for the desired vertical movements.

14. A method and apparatus to enhance the visual perception of attendees present to shows, as in claim 1, further comprising an alternative method of having the fence moved up and down over the stage by means of elevated gears positioned between the stage's floor and the venue's ceiling, such fence fitted with “O” rings, hooks or the like at the upper end of its legs through which the fence is entirely lifted by means of steel ropes connected to the elevated gears, such stage having housings compatible to the fence's legs such as pipes with their hollow upper end positioned at the same level of the stage's floor and having internal depth long enough to accommodate the fence's legs in a safe and stable resting position during the fights.

15. A method and apparatus to enhance the visual perception of attendees present to shows, as in claims 1 and 10, wherein, more than one moving system can be simultaneously used in order to give the fences or the stage's floor the required movements.

16. A method and apparatus to enhance the visual perception of attendees present to shows, as in claims 1, further comprising a surrounding platform all over the stages periphery and an advertising system adjacent to the stage's fence that uses the advantage from the movements given to the movable floor and fence by the present invention.

17. A method and apparatus to enhance the visual perception of attendees present to shows, as in claims 1 and 12, wherein an advertising system is formed by a banner and its holder which are both aggregated to the a surrounding platform, through which any sort of public communication can be addressed with the help and support of the vertical movements of the fence, introduced by the present patent.

18. A method and apparatus to enhance the visual perception of attendees present to shows, as in claims 1 and 12, wherein the adjacent advertising system adjacent to the stage's fence bears a banner holder preferably of the automatic roll-up type where the desired advertising banner will be embodied, being that banner holder positioned either at the upper or at the lower end of the fence, which up and down movements will be used to automatically pull and exhibit the banner in the desired moments, and retract and close it when needed.

19. A method and apparatus to enhance the visual perception of attendees present to shows, as in claims 1 and 12, wherein the adjacent advertising system is positioned underneath the upper edge of the surrounding platform and close to the contiguous section of the fence, in such a way it is tightly fixed to the fence by clamps, hooks or any other adequate device and preferably controlled by remote means, and goes upwards along with the fence and retracts back to the banner's holder again, when commanded through automatic or remote control, after elapsed the desired exposition period.
